(19) United States
(12) Patent Application Publication
(10) Pub. No.: US 2025/0047177 A1
(43) Pub. Date: Feb. 6, 2025

(54) METHOD FOR MANUFACTURING MOTOR CORE

(71) Applicant: TOYOTA JIDOSHA KABUSHIKI KAISHA, Toyota-shi, Aichi (JP)

(72) Inventors: Yuma IWAMOTO, Toyota-shi, Aichi-ken (JP); Takashi TAKAHASHI, Toyota-shi, Aichi-ken (JP)

(73) Assignee: TOYOTA JIDOSHA KABUSHIKI KAISHA, Toyota-shi, Aichi (JP)

(21) Appl. No.: 18/716,353

(22) PCT Filed: Dec. 8, 2022
(86) PCT No.: PCT/JP2022/045202

§ 371 Date: Jun. 4, 2024

(30) Foreign Application Priority Data
Dec. 16, 2021 (JP) 2021-203916

(51) Int. Cl. H02K 15/02

(52) U.S. Cl. CPC H02K 15/02; H02K 2213/03; H02K 2215/00

(57) ABSTRACT

In a method for manufacturing a motor core, when a crimping part for crimping and fastening electromagnetic steel plates is formed, the crimping part includes a crimping straight part, crimping tapered parts disposed on both sides of the crimping straight part, and crimping shoulder parts, the crimping shoulder parts being stepped parts formed between a planar part of other areas of the crimping part and end parts of the crimping tapered parts. When a plate thickness of the planar part is represented by T; a height of the crimping shoulder parts is represented by A; and a height of the crimping straight part is represented by B, below-shown Expressions 1 to 3 are satisfied.

$$B - A \leq T \qquad ( Expression 1 )$$

$$0.9 T \leq B \leq 1.2 T \qquad ( Expression 2 )$$

$$0 < A \leq 0.2 T \qquad ( Expression 3 )$$

### TECHNICAL FIELD

The present disclosure relates to a method for manufacturing a motor core, and for example, to a method for manufacturing a motor core by stacking electromagnetic steel plates.

### BACKGROUND ART

As disclosed in Patent Literature 1, there are cases where electromagnetic steel plates for forming a motor core are crimped and fastened in a state in which they are stacked on one another. In such a case, in a method for manufacturing a motor core according to Patent Literature 1, a force having a component that is directed from the center of the motor core toward the outer periphery thereof is applied to the crimping part, so that the effect of a compressive stress occurring in the yoke part of the motor core is reduced by shrink fitting.

### CITATION LIST

### Patent Literature

Patent Literature 1: Japanese Patent No. 6779565

### SUMMARY OF INVENTION

### Technical Problem

The applicant of the present disclosure has found the following problem. When electromagnetic steel plates are thin, it is necessary to secure the depth of the crimping part in order to ensure the crimping and fastening force while preventing the periphery of the crimping part from being fractured. However, in the method for manufacturing a motor core disclosed in Patent Literature 1, when the crimping part is formed while preventing the periphery of the crimping part from being fractured, the depth of the crimping part is shallow, so that a sufficient crimping and fastening force may not be ensured.

The present disclosure has been made in view of the above-described problem, and provides a method for manufacturing a motor core capable of ensuring a sufficient crimping and fastening force even when electromagnetic steel plates are thin.

### Solution to Problem

A method for manufacturing a motor core according to an aspect of the present disclosure is a method for manufacturing a motor core by stacking electromagnetic steel plates, in which
when a crimping part for crimping and fastening the electromagnetic steel plates is formed, the crimping part includes a crimping straight part, crimping tapered parts disposed on both sides of the crimping straight part, and crimping shoulder parts, the crimping shoulder parts being stepped parts formed between a planar part of other areas of the crimping part and end parts of the crimping tapered parts, and
when a plate thickness of the planar part is represented by T; a height of the crimping shoulder parts relative to the planar part is represented by A; and a height of the crimping straight part relative to the planar part is represented by B, below-shown Expressions 1 to 3 are satisfied.

$$B - A \leq T \qquad ( Expression 1 )$$

$$0.9 T \leq B \leq 1.2 T \qquad ( Expression 2 )$$

$$0 < A \leq 0.2 T \qquad ( Expression 3 )$$

In the above-described method for manufacturing a motor core, the plate thickness of the planar part is preferably 0.1 mm or smaller.

In the above-described method for manufacturing a motor core, a clearance between a crimping punch and a die for shaping the crimping part is preferably not shorter than 0.03 T and not longer than 0.1 T.

In the above-described method for manufacturing a motor core, the electromagnetic steel sheets are preferably made of an Fe—Co alloy.

### Advantageous Effects of Invention

According to the present disclosure, it is possible to provide a method for manufacturing a motor core capable of ensuring a sufficient crimping and fastening force even when electromagnetic steel plates are thin.

### BRIEF DESCRIPTION OF DRAWINGS

FIG. 1 is a perspective view schematically showing a state in which electromagnetic steel plates are crimped and fastened;

FIG. 2 is a cross-sectional diagram schematically showing a state in which a crimping part is formed in a workpiece to be processed;

FIG. 3 is another cross-sectional diagram schematically showing a state in which a crimping part is formed in a workpiece to be processed;

FIG. 4 is a cross-sectional diagram schematically showing a state in which a crimping part is fastened when electromagnetic steel plates are stacked;

FIG. 5 is a cross-sectional diagram schematically showing a state in which a crimping part is fastened when electromagnetic steel plates are stacked; and

FIG. 6 is a graph showing a relationship among depths of the formed crimping, fastening forces, and defect rates.

### DESCRIPTION OF EMBODIMENTS

Specific embodiments to which the present disclosure is applied will be described hereinafter in detail with reference to the drawings. However, the present disclosure is not limited to the below-shown embodiments. Further, for clarifying the explanation, the following description and the drawings are simplified as appropriate.

### EMBODIMENTS

Firstly, a method for manufacturing a motor core according to an embodiment will be briefly described. The method for manufacturing a motor core according to this embodiment is suitable, for example, for manufacturing a stator core or a rotor core of a motor, in which electromagnetic steel plates, which are core pieces, are crimped and fastened. In particular, the method for manufacturing a motor core according to this embodiment is suitable for manufacturing a motor core by using a sheet-like workpiece to be processed made of an Fe—Co alloy and having a thickness of 0.1 mm or smaller.

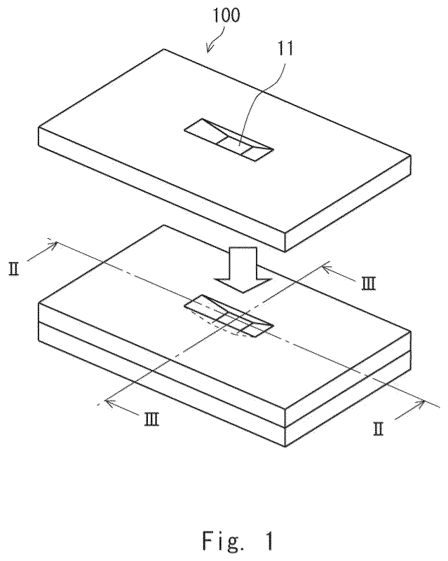

FIG. 1 is a perspective view schematically showing a state in which electromagnetic steel plates are crimped and fastened. Note that in FIG. 1, the periphery of the crimping part of electromagnetic steel plates 100 is shown in a simplified manner. In the method for manufacturing a motor core, for example, a punching-out step of forming a hole by punching out a first predetermined place (e.g., a place corresponding to a slot or the like) in a workpiece to be processed while moving the workpiece to be processed in a forward direction, a crimping forming step of forming a crimping part in a second predetermined place in the workpiece to be processed, and a stacking step of crimping and fastening a punched-out electromagnetic steel plate 100 as shown in FIG. 1 while punching out the electromagnetic steel plate from the workpiece to be processed are successively carried out.

Next, a flow of forming a crimping part in a workpiece to be processed by the above-described crimping forming step, and the shape of the formed crimping part will be described. Here, firstly, a configuration of a crimping apparatus for forming a crimping part in a workpiece to be processed will be briefly described.

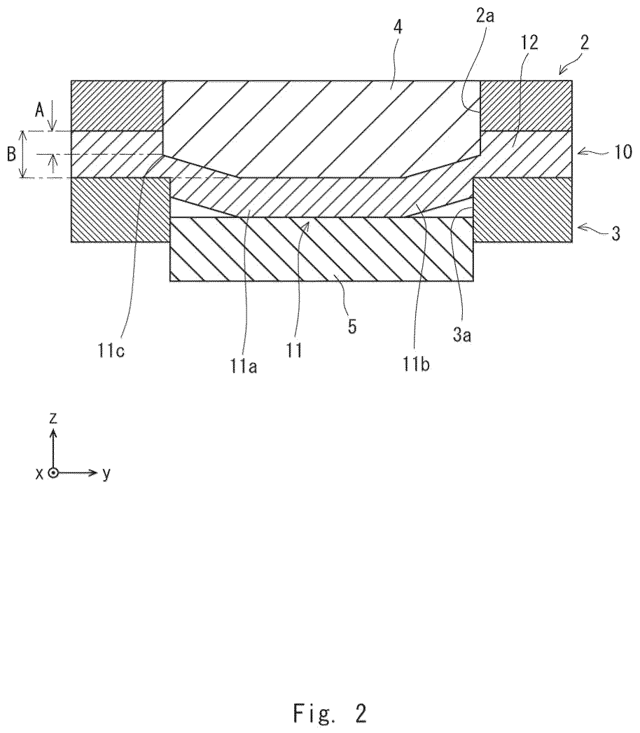

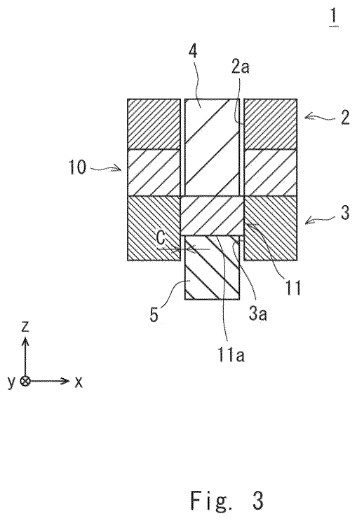

FIGS. 2 and 3 schematically show a state in which a crimping part is formed in a workpiece to be processed. FIG. 2 is a cross-sectional diagram of a place in the workpiece to be processed corresponding to a line II-II in FIG. 1, and FIG. 3 is a cross-sectional diagram of a place in the workpiece to be processed corresponding to a line III-III in FIG. 1.

Note that the following description will be given by using a three-dimensional (XYZ) coordinate system for clarifying the explanation. As shown in FIG. 2, a crimping apparatus 1 includes a stripper 2, a die 3, a crimping punch 4, and a pushing-up part 5.

The stripper 2 includes a through part 2a having a peripheral shape corresponding to a peripheral shape of a crimping part 11 formed in a workpiece to be processed 10 as viewed in the Z-axis direction. The stripper 2 is movable, for example, in the Z-axis direction.

The die 3 also includes a through part 3a having a peripheral shape corresponding to the peripheral shape of the crimping part 11 formed in the workpiece to be processed 10 as viewed in the Z-axis direction. The die 3 is disposed on the Z-axis negative side with respect to the stripper 2. Note that the stripper 2 and the die 3 are arranged so that the through part 2a of the stripper 2 and the through part 3a of the die 3 coincide with each other as viewed in the Z-axis direction.

The crimping punch 4 is movable in the Z-axis direction in a state in which it is inserted into the through part 2a of the stripper 2. The end part of the crimping punch 4 on the Z-axis negative side has a roughly inverted trapezoidal shape as viewed in the X-axis direction and a roughly rectangular shape as viewed in the Y-axis direction and in the Z-axis direction.

The pushing-up part 5 is movable in the Z-axis direction in a state in which it is inserted into the through part 3a of the die 3. When the workpiece to be processed 10 is conveyed after the crimping part 11 is formed therein, the pushing-up part 5 pushes up the workpiece to be processed 10 to the Z-axis positive side through the crimping part 11.

Next, a flow of forming the crimping part 11 in the workpiece to be processed 10 by using the above-described crimping apparatus 1 will be described. Firstly, a workpiece to be processed 10 that has been conveyed to the crimping apparatus 1 is sandwiched between the stripper 2 and the die 3. Next, the crimping punch 4 is moved to the Z-axis negative side, so that the part thereof on the Z-axis negative side projects from the stripper 2 to the Z-axis negative side, so that the workpiece to be processed 10 is pressed to a second predetermined place thereof. As a result, the crimping part 11 is formed in the workpiece to be processed 10.

Note that since the end part of the crimping punch 4 on the Z-axis negative side has a roughly inverted trapezoidal shape as shown in FIG. 2, the crimping part 11 includes, as a result, a crimping straight part 11a, crimping tapered parts 11b, and crimping shoulder parts 11c as viewed in the X-axis direction.

As shown in FIG. 2, the surfaces on the Z-axis positive and negative sides of the crimping straight part 11a are roughly parallel to the XY-plane. The crimping straight part 11a is disposed, for example, roughly at the center of the crimping part 11 in the Y-axis direction.

As shown in FIG. 2, the crimping tapered parts 11b are disposed on both sides of the crimping straight part 11a in the Y-axis direction. Therefore, the surfaces on the Z-axis positive and negative sides of the crimping tapered part 11b disposed on the Y-axis positive side are inclined in such a manner that the more it is positioned on the Y-axis positive side, the more it is positioned on the Z-axis positive side. Further, the surfaces on the Z-axis positive and negative sides of the crimping tapered part 11b disposed on the Y-axis negative side are inclined in such a manner that the more it is positioned on the Y-axis negative side, the more it is positioned on the Z-axis positive side.

As shown in FIG. 2, each of the crimping shoulder parts 11c is a stepped part formed between the end part on the Y-axis positive or negative side of the crimping tapered parts 11b and a planar part 12 of the other areas of the crimping part 11 of the workpiece to be processed 10. For example, each of the crimping shoulder parts 11c is a stepped part formed between the end part on the Y-axis positive or negative side of the crimping tapered parts 11b on the Z-axis positive side and the surface on the Z-axis positive side of the planar part 12 of the workpiece to be processed 10.

Further, as shown in FIG. 2, when the plate thickness of the planar part 12 of the workpiece to be processed 10 is represented by T; the height of the crimping shoulder parts 11c relative to the planar part 12 (i.e., the height of the crimping shoulders) is represented by A; and the height of the crimping straight part 11a relative to the planar part 12 (i.e., the depth of the formed crimping) is represented by B, the crimping part 11 is formed so that the below-shown (Expression 1) to (Expression 3) are satisfied.

$$B - A \leq T \qquad ( Expression 1 )$$

$$0.9 T \leq B \leq 1.2 T \qquad ( Expression 2 )$$

$$0 < A \leq 0.2 T \qquad ( Expression 3 )$$

By securing the height of the crimping shoulders as described above, it is possible to secure the contact area (fastening area) between the crimping part of an electrical steel plate 100 and that of another electrical steel plates 100 adjacent thereto in the Z-axis direction when the electrical steel plates 100 are crimped and fastened by securing the depth of the formed crimping, and to form the crimping part 11 with the inclination angle of the crimping tapered parts 11b at which the periphery of the crimping part 11 is not fractured.

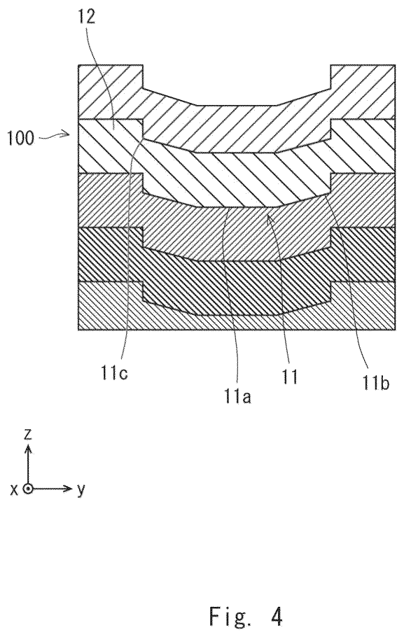

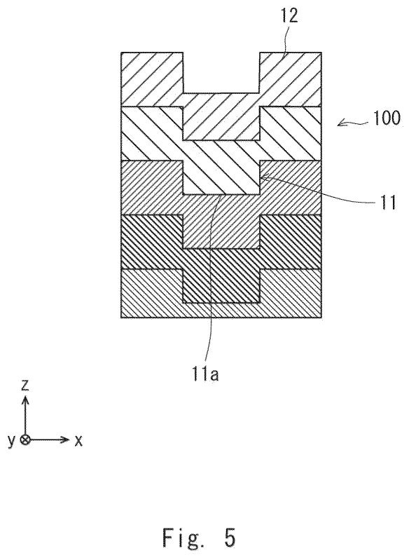

Note that FIGS. 4 and 5 schematically show the fastening state of crimping parts when electrical steel plates are stacked. FIG. 4 is a cross-sectional diagram of the stacked electrical steel plates 100 at a place corresponding to a line II-II in FIG. 1, and FIG. 5 is a cross-sectional diagram of the stacked electrical steel plates 100 at a place corresponding to a line III-III in FIG. 1.

As shown in FIGS. 4 and 5, the projecting part formed in the surface on the Z-axis negative side of the crimping part 11 of an electrical steel plate 100 is engaged with the recessed part formed in the surface on the Z-axis positive side of the crimping part 11 of another electrical steel plate 100 adjacent thereto on the Z-axis negative side, and therefore it is crimped and fastened.

Note that in this embodiment, by securing the height of the crimping shoulders as described above, it is possible to secure the contact area between the crimping part of an electrical steel plate 100 and that of another electrical steel plate 100 adjacent thereto in the Z-axis direction when the electrical steel plates 100 are crimped and fastened by securing the depth of the formed crimping, and to form the crimping part 11 with the inclination angle of the crimping tapered parts 11b at which the periphery of the crimping part 11 is not fractured. Therefore, even if the electrical steel plates 100 are thin and are made of a material that cannot be easily molded (or shaped), such as an Fe—Co alloy, it is possible to ensure a sufficient crimping and fastening force without causing the crimping part 11 to be fractured.

In addition, since the crimping tapered parts 11b can be formed at a gentle angle at which the periphery of the crimping part 11 is not fractured, it is possible to improve the manufacturing yield rate of rotor cores. Further, the size of the crimping part 11 can be reduced, and hence the resistance of the crimping part 11 can be reduced.

Note that the clearance C between the through part 3a of the die 3 and the periphery of the crimping punch 4 is preferably not shorter than 0.03 T and not longer than 0.1 T. In this way, the crimping punch 4 can be moved to the Z-axis negative side in a satisfactory fashion while preventing the workpiece to be processed 10 from being fractured.

### EXAMPLES

In examples, as shown in Table 1, fastening forces were measured and fractures of crimping parts were observed while changing the depth of the formed crimping in a range of 0.8 T to 1.5 T and changing the height of the crimping shoulders in a range of 0 T to 0.2 T.

TABLE 1

| Depth of | Height of | Fastening | |
|---|---|---|---|
| Formed | Crimping | Force | Accepted |
| Crimping | Shoulder | [N] | or Not |
| 0.8T | 0.00T | — | x |
| 0.81T | 0.00T | — | x |
| 0.84T | 0.00T | — | x |
| 0.99T | 0.00T | 2.2 | ∘ |
| 1.01T | 0.01T | 2.3 | ∘ |
| 0.98T | 0.00T | 2.9 | ∘ |
| 1.01T | 0.01T | 2.8 | ∘ |
| 1.01T | 0.01T | 2.5 | ∘ |
| 1.11T | 0.11T | 2.6 | ∘ |
| 1.10T | 0.10T | 2.5 | ∘ |
| 1.09T | 0.09T | 3.1 | ∘ |
| 1.11T | 0.11T | 3 | ∘ |
| 1.12T | 0.12T | 2.9 | ∘ |
| 1.23T | 0.20T | 3.7 | ∘ |
| 1.22T | 0.20T | 3.6 | ∘ |
| 1.18T | 0.18T | 3.4 | ∘ |
| 1.20T | 0.20T | 3.4 | ∘ |
| 1.21T | 0.20T | 3.4 | ∘ |
| 1.30T | 0.20T | 4 | ∘ |
| 1.29T | 0.20T | — | x |
| 1.40T | 0.20T | — | x |
| 1.39T | 0.20T | 3.9 | ∘ |
| 1.50T | 0.20T | — | x |
| 1.50T | 0.20T | — | x |

Note that in the examples, the length of the crimping part 11 in the X-axis direction was 0.5 mm; the length of the crimping part 11 in the Y-axis direction was 3 mm; the plate thickness T of the planar part 12 of the workpiece to be processed 10 was 0.1 mm; the length of the crimping straight part 11a in the Y-axis direction was 1 mm; and the taper height that was obtained by subtracting the height of the crimping shoulders from the depth of the formed crimping (i.e., the above-described value expressed as B-A) was equal to the plate thickness T of the planar part 12 of the workpiece to be processed 10, i.e., was 0.1 mm, in each of possible combinations of values of the depth of the formed crimping and the height of the crimping shoulders shown in Table 1. Further, workpieces to be processed 10 were punched out under the conditions that the punching load of the crimping punch 4 was 200 tons; the SPM (Shots Per Minute) of the crimping punch 4 was 100; and the temperature of the crimping punch 4 was 23° C.

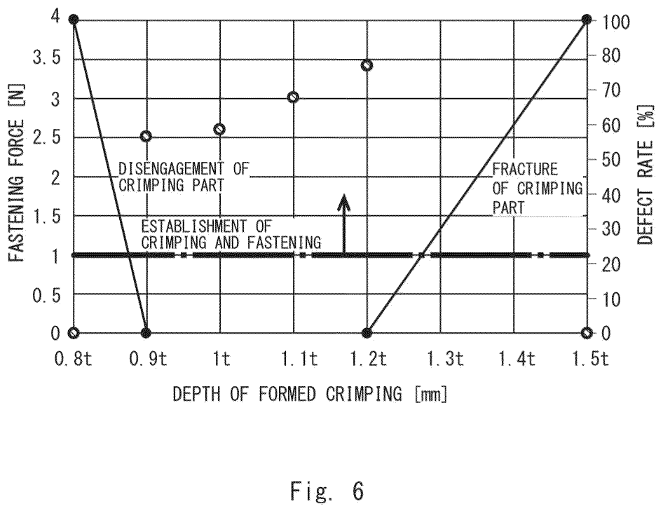

Note that FIG. 6 shows a relationship among depths of the formed crimping, fastening forces, and defect rates. Note that in the examples, when the fastening force was 1 N or larger and the crimping part 11 was not fractured, the product or the like was regarded as an accepted product.

As shown in Table 1, when the depth of the formed crimping was 0.80 T, 0.81 T or 0.84 T, the product or the like could not satisfy the conditions as an accepted product. Further, as shown in Table 1, when the depth of the formed crimping was 1.29 T, 1.40 T or 1.50 T, the product or the like could not satisfy the conditions as an accepted product.

As shown in Table 1, when the depth of the formed crimping was 1.21 T, 1.22 T, 1.23 T, 1.30 T or 1.39 T, the product or the like could satisfy the conditions as an accepted product. However, as shown in FIG. 6, when the depth of the formed crimping exceeds 1.2 T, there is a possibility that the crimping part 11 may be fractured.

In contrast, as shown in Table 1, when the depth of the formed crimping is 0.98 T, 0.99 T, 1.01 T, 1.09 T, 1.10 T, 1.11 T, 1.12 T, 1.18 T or 1.20 T, the product or the like could satisfy the conditions as an accepted product. Further, as shown in FIG. 6, there is no probability that the fastening between crimping parts 11 is disengaged from each other or the crimping part 11 is fractured.

As described above, it can be understood that when the taper height obtained by subtracting the height of the crimping shoulders from the depth of the formed crimping is equal to the plate thickness T of the planar part 12 of the workpiece to be processed 10, and the depth of the formed crimping is not smaller than 0.9 T and not larger than 1.2 T and the height of the crimping shoulders is larger than 0 and not larger than 0.2 T, the product or the like can satisfy the conditions as an accepted product without fail.

The present disclosure is not limited to the above-described embodiments, and they can be modified as appropriate without departing from the scope and spirit of the disclosure.

This application is based upon and claims the benefit of priority from Japanese patent application No. 2021-203916, filed on Dec. 16, 2021, the disclosure of which is incorporated herein in its entirety by reference.

### REFERENCE SIGNS LIST

1 CRIMPING APPARATUS
2 STRIPPER
2a THROUGH PART
3 DIE
3a THROUGH PART
4 CRIMPING PUNCH
5 PUSHING UP PART
10 WORKPIECE TO BE PROCESSED
11 CRIMPING PART
11a CRIMPING STRAIGHT PART
11b CRIMPING TAPERED PART
11c CRIMPING SHOULDER
12 PLANE PART
100 ELECTROMAGNETIC STEEL PLATE
A HEIGHT OF CRIMPING SHOULDER PART RELATIVE TO PLANE PART
B HEIGHT OF CRIMPING STRAIGHT PART RELATIVE TO PLANE PART
C CLEARANCE BETWEEN THROUGH PART OF DIE AND PERIPHERY OF CRIMPING PUNCH
T THICKNESS OF PLANE PART OF WORKPIECE TO BE PROCESSED

1. A method for manufacturing a motor core by stacking electromagnetic steel plates, wherein
when a crimping part for crimping and fastening the electromagnetic steel plates is formed, the crimping part comprises a crimping straight part, crimping tapered parts disposed on both sides of the crimping straight part, and crimping shoulder parts, the crimping shoulder parts being stepped parts formed between a planar part of other areas of the crimping part and end parts of the crimping tapered parts, and
when a plate thickness of the planar part is represented by T; a height of the crimping shoulder parts relative to the planar part is represented by A; and a height of the crimping straight part relative to the planar part is represented by B, below-shown Expressions 1 to 3 are satisfied.
$$B - A \leq T \qquad ( Expression 1 )$$
$$0.9 T \leq B \leq 1.2 T \qquad ( Expression 2 )$$
$$0 < A \leq 0.2 T \qquad ( Expression 3 )$$

2. The method for manufacturing a motor core according to claim 1, wherein the plate thickness of the planar part is 0.1 mm or smaller.

3. The method for manufacturing a motor core according to claim 1, wherein a clearance between a crimping punch and a die for shaping the crimping part is not shorter than 0.03 T and not longer than 0.1 T.

4. The method for manufacturing a motor core according to claim 1, wherein the electrical steel sheets are made of an Fe—Co alloy.
